(19) United States
(12) Patent Application Publication
(10) Pub. No.: US 2026/0346653 A1
(43) Pub. Date: Nov. 5, 2026

(54) Tire for a Heavy-Duty Vehicle for Off-Road Use Comprising Sidewalls Protected Against Attack

(71) Applicant: COMPAGNIE GENERALE DES ETABLISSEMENTS MICHELIN, Clermont-Ferrand (FR)

(72) Inventors: Franck NUGIER, Clermont-Ferrand Cedex 9 (FR); Adrien TRAVERSE, Clermont-Ferrand Cedex 9 (FR); Hichem REHAB, Clermont-Ferrand Cedex 9 (FR)

(21) Appl. No.: 19/118,599

(22) PCT Filed: Sep. 29, 2023
(86) PCT No.: PCT/EP2023/077154

§ 371 Date: Apr. 4, 2025

(30) Foreign Application Priority Data
Oct. 5, 2022 (FR) FR2210178

(51) Int. Cl. B60C 13/02

(52) U.S. Cl. CPC B60C 13/02; B60C 2200/065; B60C 2200/14

(57) ABSTRACT

A tire (1) for a heavy-duty vehicle for off-road use and seeks to protect the sidewalls (2) thereof against mechanical attack. A sidewall (2) having, on a sidewall outer face (21), a plurality of circumferentially distributed protrusions (6). Every protrusion (6) has a mean thickness (E), a mean circumferential length (A) and a mean radial height (C) and is separated from the adjacent protrusions by a mean circumferential pitch (P). The mean circumferential length (A) is at least equal to 20% of the mean circumferential pitch (P), the mean circumferential pitch (P) is at most equal to 20% of the free outside diameter (De), the mean thickness (E) is at least equal to 0.2% of the free outside diameter (De), the radial distance (D) is at most equal to 50% of the section height (H) and the mean radial height (C) is at least equal to 2% of the section height (H).

The present invention relates to a tire for a heavy-duty vehicle for off-road use, intended to run on uneven and stony ground such as, for example, a construction plant vehicle or a vehicle for military use. This invention relates more particularly to the sidewalls of such a tire.

By definition, the circumferential or longitudinal direction is the direction of rotation of the tire, the axial or transverse direction is the direction parallel to the axis of rotation of the tire and the radial direction is a direction perpendicular to the axis of rotation of the tire.

Generally, a tire comprises two sidewalls which are two lateral portions connecting a tread respectively to two beads. The tread is positioned on the circumference of the tire and is intended to become worn while the tire is running. The beads are intended to ensure the mounting of the tire on a rim.

More specifically, a sidewall usually comprises, axially from the outside to the inside of the tire: at least one outer layer of rubber material, which is in contact with the atmospheric air and generally comprises, on an outer face, an assembly of recessed or raised markings; a carcass reinforcement, comprising at least one layer of metal reinforcers coated in a rubber material; and at least one inner layer of rubber material, which is intended to be in contact with the inflation gas when the tire is mounted and inflated on its rim.

A recurring problem with tires for heavy-duty vehicles for off-road use is that they suffer mechanical attack, when running on uneven and non-tarmacked ground, from stones and other blunt objects present on said ground, for example metal objects. Such mechanical attack relates essentially to the tread and the sidewalls of the tire. As regards the sidewalls more particularly, such mechanical attack is likely to initiate cracks, which may spread into the sidewall of the tire and lead to damage to the tire carcass liable to cause the tire to burst and therefore need to be removed from the vehicle.

In order to combat the initiation and spread of cracks in the sidewall, it has been proposed, for example in documents JP 4202168 B2 and EP 3523141 B1, to incorporate circumferentially distributed protrusions on the outer face of the sidewalls.

The inventors have set themselves the objective of reducing the sensitivity to mechanical attack of the sidewalls of a tire intended to be fitted to a heavy-duty vehicle for off-road use, through the selection of an optimized circumferential distribution of sidewall protrusions.

This objective has been achieved by means of a tire for a heavy-duty vehicle for off-road use, comprising two sidewalls that connect a tread, intended to come into contact with the ground, respectively to two beads, intended to come into contact with a rim,
the tire having an axis of revolution, a free outside diameter, measured on the tire not mounted on its rim and not inflated, and a section height, within the meaning of the “European Tire and Rim Technical Organization” standard,
at least one sidewall comprising, on a sidewall outer face in contact with the atmospheric air, a plurality of protrusions standing out in relief with respect to the sidewall outer face and distributed circumferentially in a circumferential direction of the tire,
every protrusion having a mean thickness, measured perpendicular to the sidewall outer face, a mean circumferential length, measured at mid-thickness of the protrusion in an axial plane parallel to the axis of revolution, and a mean radial height, measured at mid-thickness of the protrusion in a circumferential plane, perpendicular to the axis of revolution,
every protrusion being positioned radially with respect to a tread end at a radial distance, measured at mid-thickness of the protrusion at the point corresponding to the maximum thickness of the protrusion,
two consecutive protrusions being circumferentially separated by a mean circumferential distance, measured at mid-thickness of said protrusions in an axial plane,
the mean circumferential pitch separating two consecutive protrusions being the sum of the mean circumferential length of a protrusion and the mean circumferential distance between said two consecutive protrusions,
the mean circumferential length being at least equal to 20% of the mean circumferential pitch,
the mean circumferential pitch being at most equal to 20% of the free outside diameter,
the mean thickness being at least equal to 0.2% of the free outside diameter,
the radial distance being at most equal to 50% of the section height,
and the mean radial height being at least equal to 2% of the section height.

The invention essentially consists in protecting, against mechanical attack, a sidewall of a tire intended to run off-road, by means of a circumferential distribution of protrusions that is optimized in terms of the mean dimensions of the protrusions, the mean circumferential pitch at which the protrusions are distributed, and the radial positioning of the protrusions with respect to the tread. The objective is to have a total volume of protrusions that is sufficient to afford effective protection, but which, in order to minimize the quantity of material, is not excessively high.

From a geometric standpoint, every protrusion has a mean thickness, measured perpendicular to the sidewall outer face, a mean circumferential length, measured at mid-thickness of the protrusion in an axial plane parallel to the axis of revolution, and a mean radial height, measured at mid-thickness of the protrusion in a circumferential plane perpendicular to the axis of revolution. A protrusion is not, generally, strictly parallelepipedal, but may have a relatively complex shape, hence the benefit of characterizing it geometrically in terms of mean dimensions, measured at mid-thickness of the protrusion. The aforementioned mean dimensions are usually, although not necessarily, identical for all of the protrusions.

The radial distance of one protrusion with respect to a tread end characterizes its position on the sidewall. The radial distance is usually, although not necessarily, identical for all of the protrusions.

The mean circumferential pitch separating two consecutive protrusions, and defined as being the sum of the mean circumferential length of a protrusion and the mean circumferential distance between said two consecutive protrusions, characterizes the density of raised material around the wheel. The circumferential pitch is generally, although not compulsorily, constant.

According to the invention, the mean circumferential length is at least equal to 20% of the mean circumferential pitch. In other words, the protrusion content by volume, defined as being the ratio between the mean circumferential length of the protrusion and the mean circumferential pitch separating two consecutive protrusions, is at least equal to 20%, thereby ensuring a sufficient quantity of rubber material to protect the sidewall.

Again according to the invention, the mean circumferential pitch is at most equal to 20% of the free outside diameter, thereby ensuring a uniform and sufficiently dense distribution of the protrusions and, as a result, effective protection over the entire circumference.

Still according to the invention, the mean thickness is at least equal to 0.2% of the free outside diameter. This feature ensures a sufficient thickness of rubber material to possibly push obstacles aside and limit the attack from said obstacles.

According to another essential feature of the invention, the radial distance is at most equal to 50% of the section height. This condition enables the protrusions, and therefore the associated protection, to be positioned radially in a sidewall region relatively close to the ground on which the foreign bodies liable to attack it are present.

According to another essential feature of the invention, the mean radial height is at least equal to 2% of the section height. This condition makes it possible to have a protrusion that is resistant to any chunking that might result from the attack.

Advantageously, the mean circumferential length is at least equal to 25% of the mean circumferential pitch. This minimum material content by volume ensures even more effective protection.

Advantageously also, the mean circumferential pitch is at most equal to 18% of the free outside diameter. A lower mean circumferential pitch, namely a higher density of protrusions, improves still further the effectiveness of the protection around the entire circumference.

More advantageously still, the mean thickness is at least equal to 0.25% of the free outside diameter. The higher the mean thickness, the better the protection.

Advantageously, the radial distance is at most equal to 30% of the section height. The closer the protrusions are to the ground, the higher the probability that they will work effectively against attack.

Advantageously also, the mean radial height is at least equal to 4% of the section height. The higher the mean radial height, the greater the resistance of the protrusion to chunking.

Again advantageously, the mean radial height is at most equal to 25% of the section height, preferably at most equal to 20% of the section height. This limit on the radial height of the protrusion makes it possible to limit to a strict minimum the volume of rubber material and the rise in temperature in the sidewall, which is liable to lead to deterioration thereof.

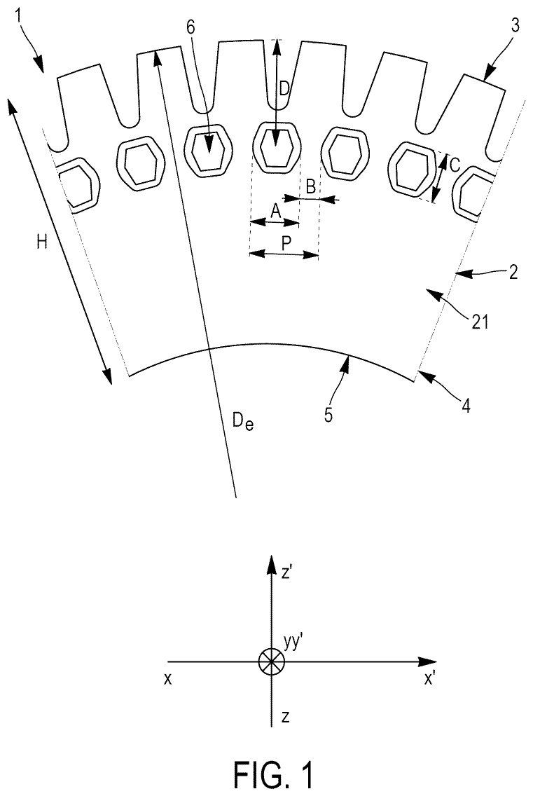

The features of the invention are illustrated by the following FIGS. 1 to 4 which are schematic and not drawn to scale:

FIG. 1: Side view of a portion of a tire according to the invention,

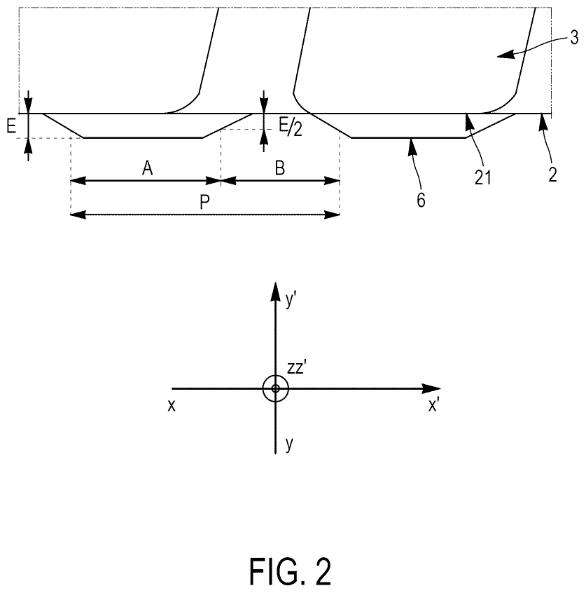

FIG. 2: View from above of a portion of a tire according to the invention,

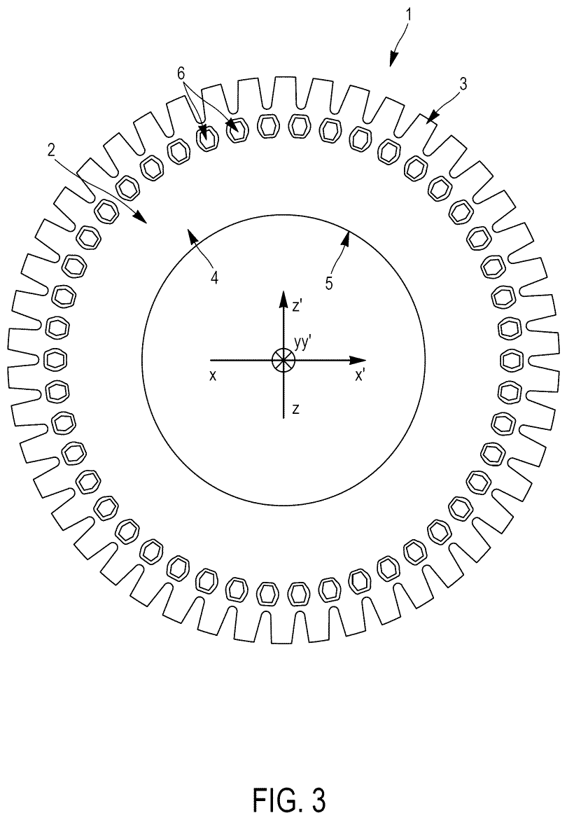

FIG. 3: Side view of an entire tire according to the invention,

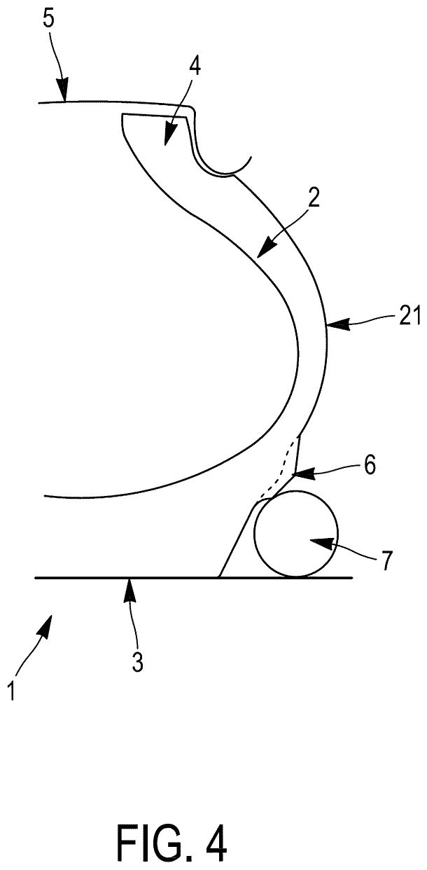

FIG. 4: Meridian half-section of a tire according to the invention, inflated and compressed.

FIG. 1 is a side view of a portion of a tire according to the invention. The tire 1 for a heavy-duty vehicle for off-road use comprises two sidewalls 2 that connect a tread 3, intended to come into contact with the ground, respectively to two beads 4, intended to come into contact with a rim 5. FIG. 1 is depicted in a cylindrical frame of reference, in which the circumferential or longitudinal direction XX′ is the direction of rotation of the tire, the axial or transverse direction YY′ is the direction parallel to the axis of rotation of the tire, and the radial direction ZZ′ is a direction perpendicular to the axis of rotation of the tire.

The tire 1 has an axis of revolution YY′, a free outside diameter De, measured on the tire 1 not mounted on its rim 5 and not inflated, and a section height H, within the meaning of the “European Tire and Rim Technical Organization” standard. The sidewall 2 in FIG. 1 comprises, on a sidewall outer face 21 in contact with the atmospheric air, a plurality of protrusions 6 standing out in relief with respect to the sidewall outer face 21 and distributed circumferentially in a circumferential direction XX′ of the tire.

Every protrusion 6 has a mean thickness E (not indicated in FIG. 1), measured perpendicular to the sidewall outer face 21, a mean circumferential length A, measured at mid-thickness of the protrusion in an axial plane XY parallel to the axis of revolution YY′, and a mean radial height C, measured at mid-thickness of the protrusion in a circumferential plane XZ, perpendicular to the axis of revolution YY′. Every protrusion 6 is positioned radially with respect to a tread end at a radial distance D, measured at mid-thickness of the protrusion at the point corresponding to the maximum thickness of the protrusion. Two consecutive protrusions 6 are circumferentially separated by a mean circumferential distance B, measured at mid-thickness of said protrusions in an axial plane XY. The mean circumferential pitch P separating two consecutive protrusions 6 is the sum of the mean circumferential length A of a protrusion 6 and the mean circumferential distance B between said two consecutive protrusions 6. According to the invention, the mean circumferential length A is at least equal to 20% of the mean circumferential pitch P, the mean circumferential pitch P is at most equal to 20% of the free outside diameter De, the mean thickness E is at least equal to 0.2% of the free outside diameter De, the radial distance D is at most equal to 50% of the section height H and the mean radial height Cis at least equal to 2% of the section height H.

FIG. 2 is a view from above of a portion of a tire according to the invention. This figure more particularly illustrates the positioning of the protrusions 6 standing out in relief relative to the outer face 21 of the sidewall 2 and radially to the inside of the tread 3. It also depicts the mean thickness E of a protrusion 6, measured perpendicular to the sidewall outer face 21, the mean circumferential length A of a protrusion 6, and the mean circumferential distance B and the mean circumferential pitch P, which is the sum of the mean circumferential length A and of the mean circumferential distance B, the characteristics A, B and P all being measured in an axial plane XY, at mid-thickness of said protrusions 6, namely at an axial distance E/2 from the sidewall outer face 21. In the embodiment depicted, the cross section of a protrusion 6 in an axial plane XY has a substantially trapezoidal shape which is particularly effective in terms of protection. The sides of the trapezium, connecting its bases, have a suitable inclination with respect to the direction perpendicular to the sidewall outer face, and are connected to the sidewall by fillet radiuses of optimized radius.

FIG. 3 is a side view of an entire tire according to the invention. This figure more particularly illustrates a constant-pitch circumferential distribution of protrusions 6, positioned in a radially outer part of the sidewall 2 of the tire 1, radially to the inside of a tread 3.

FIG. 4 is a meridian half-section through a tire according to the invention, inflated and compressed. This figure in particular illustrates the function of protecting the sidewall 2, extending between the tread 3 and the bead 4, performed by the protrusion 6 standing out in relief with respect to the sidewall outer face 21, against an obstacle 7 when the tire 1, mounted and inflated on its rim 5, is compressed. The exterior profile of the protrusion 6 before the tire is compressed is indicated in dotted line.

Table 1 below presents an example of characteristics according to the invention, for a tire of size 59/80 R 63 intended to be fitted to a heavy construction plant vehicle of dumper type:

TABLE 1

| Characteristics | 59/80 R 63 | | Comments |
|---|---|---|---|
| Free outside diameter (De) | 4027 | mm | |
| Section height (H) | 1200 | mm | |
| Mean thickness (E) | 23 | mm | E/De = 0.6% > 0.2% |
| | | | E/De = 0.6% > 0.25% |
| Mean circumferential length (A) | 136 | mm | A/P = 60% > 20% |
| | | | A/P = 60% > 25% |
| Mean radial height (C) | 135 | mm | C/H = 11% > 2% |
| | | | C/H = 11% > 4% |
| | | | C/H = 11% < 25% |
| | | | C/H = 11% < 20% |
| Mean circumferential distance (B) | 89 | mm | |
| Mean circumferential pitch (P) | 225 | mm | P/De = 6% < 20% |
| | | | P/De = 6% < 18% |
| Radial distance (D) | 345 | mm | D/H = 29% < 50% |
| | | | D/H = 29% < 30% |

1. A tire for a heavy-duty vehicle for off-road use, comprising two sidewalls that connect a tread, intended to come into contact with the ground, respectively to two beads, intended to come into contact with a rim,
the tire having an axis of revolution (YY′), a free outside diameter (De), measured on the tire not mounted on its rim and not inflated, and a section height (H), within the meaning of the “European Tire and Rim Technical Organization” standard,
at least one sidewall comprising, on a sidewall outer face in contact with the atmospheric air, a plurality of protrusions standing out in relief with respect to the sidewall outer face and distributed circumferentially in a circumferential direction (XX′) of the tire,
every protrusion having a mean thickness (E), measured perpendicular to the sidewall outer face, a mean circumferential length (A), measured at mid-thickness of the protrusion in an axial plane (XY) parallel to the axis of revolution (YY′), and a mean radial height (C), measured at mid-thickness of the protrusion in a circumferential plane (XZ), perpendicular to the axis of revolution (YY′),
every protrusion being positioned radially with respect to a tread end at a radial distance (D), measured at mid-thickness of the protrusion at the point corresponding to the maximum thickness of the protrusion,
two consecutive protrusions being circumferentially separated by a mean circumferential distance (B), measured at mid-thickness of said protrusions in an axial plane (XY),
the mean circumferential pitch (P) separating two consecutive protrusions being the sum of the mean circumferential length (A) of a protrusion and the mean circumferential distance (B) between said two consecutive protrusions,
wherein the mean circumferential length (A) is at least equal to 20% of the mean circumferential pitch (P), the mean circumferential pitch (P) is at most equal to 20% of the free outside diameter (De), the mean thickness (E) is at least equal to 0.2% of the free outside diameter (De), the radial distance (D) is at most equal to 50% of the section height (H) and the mean radial height (C) is at least equal to 2% of the section height (H).

2. The tire according to claim 1, wherein the mean circumferential length (A) is at least equal to 25% of the mean circumferential pitch (P).

3. The tire according to claim 1, wherein the mean circumferential pitch (P) is at most equal to 18% of the free outside diameter (De).

4. The tire according to claim 1, wherein the mean thickness (E) is at least equal to 0.25% of the free outside diameter (De).

5. The tire according to claim 1, wherein the radial distance (D) is at most equal to 30% of the section height (H).

6. The tire according to claim 1, wherein the mean radial height (C) is at least equal to 4% of the section height (H).

7. The tire according to claim 1, wherein the mean radial height (C) is at most equal to 25% of the section height (H).

8. The tire according to any claim 1, wherein the mean radial height (C) is at most equal to 20% of the section height (H).
